(19) United States
(12) Patent Application Publication
(10) Pub. No.: US 2018/0365318 A1
(43) Pub. Date: Dec. 20, 2018

(54) SEMANTIC ANALYSIS OF SEARCH RESULTS TO GENERATE SNIPPETS RESPONSIVE TO RECEIPT OF A QUERY

(71) Applicant: Microsoft Technology Licensing, LLC, Redmond, WA (US)

(72) Inventors: Li YI, Bellevue, WA (US); Guihong CAO, Sammamish, WA (US); Daniel DEUTSCH, Bellevue, WA (US); Richard QIAN, Redmond, WA (US)

(21) Appl. No.: 15/627,348

(22) Filed: Jun. 19, 2017

(51) Int. Cl. G06F 17/30

(52) U.S. Cl. CPC G06F 17/30675; G06F 17/30887; G06F 17/30011; G06F 17/30864

(57) ABSTRACT

Described herein are technologies relating to parsing at least one document to return a snippet that includes information that answers a question set forth in a query. A ranked list of search results is generated based upon the query, and a document represented by a search result in the ranked list of search results is retrieved from a search engine cache or a web server that hosts the document. The document is parsed, and snippets in the document are extracted and ranked. At least a most highly-ranked snippet is returned to a client computing device as including an answer to the question set forth in the query.

### BACKGROUND

Search engines are configured to return search results in response to receipt of a query, wherein the search results represent documents that have been identified by the search engine as being relevant to the query. A query issued to a search engine is typically classified as being of one of three types: 1) navigational; 2) informational, and 3) transactional. A navigational query is a query set forth by a user with the intent of finding a particular website or webpage. An informational query is a query set forth by a user with the intent of finding one or more websites or webpages that include information that is of interest to the user (e.g., “what is the capital of Idaho?”). A transactional query is a query set forth by a user with the intent of completing a transaction, such as making a purchase.

Search engines have developed several techniques for providing users with appropriate information in response to receipt of an informational query. In an exemplary conventional approach, search engines have developed “instant answer” indices, such that when a user sets forth an informational query with the intent of learning a specific fact, an “instant answer” index can be accessed and the fact is returned to the user. For instance, when a user sets forth the query “what is the capital of Idaho”, the search engine accesses the “instant answer index”, and returns “Boise” as an instant answer on the search engine results page (SERP). Therefore, the user need not leave the SERP (i.e., need not open a document) to obtain the fact for which the user was searching. In another exemplary conventional approach, search engines can surface portions of documents based upon keyword matching. With more specificity, the query includes a keyword, and a document represented by a search result also includes the keyword. The search engine can locate the keyword in the document, and can surface a sentence that includes the keyword on the SERP. If the sentence happens to include the fact for which the user was searching, the user need not leave the SERP to obtain such fact.

For certain types of queries and/or documents, however, the approaches described above may fail to provide the users with information being sought by the users. For example, when a fact is subject to change, the instant answer approach described above may fail, as the “instant answer index” may not include the most recent information. In an example, when a user issues the query “what is on the menu at Restaurant X tonight?”, an instant answer may be inappropriate, as the menu may change nightly. Similarly, the portion of the document that includes the keyword may not be relevant to the informational need of the user. This results in the user selecting a search result, and often searching through several pages of a website in an attempt to locate the desired information.

### SUMMARY

The following is a brief summary of subject matter that is described in greater detail herein. This summary is not intended to be limiting as to the scope of the claims.

Described herein are technologies relating to identifying snippets in documents in response to receipt of a query from a client computing device, wherein the documents are parsed to identify the snippets such that an informational need of an issuer of the query is addressed. In more detail, a user sets forth a query to a search engine, wherein the query can be classified as informational in nature. For instance, the query can include a question. The search engine performs a search over a search engine index to generate search results based on the query, and the search engine ranks the search results to construct a ranked list of search results. Further, responsive to ascertaining that the query is informational in nature, the search engine can identify at least one document represented by a search result in the search results, wherein the at least one document is likely to include information requested by the user via the query. For example, the search engine can maintain a list of domains that often include answers to questions set forth to the search engine by users of the search engine. The search engine, for instance, may learn the domains. Still further, the search engine may categorize domains as a function of query intent—e.g., menu pages when the user query requests menu information.

When a search result is in the top M search results, and a domain in the search result is equivalent to a domain in the list of domains, the search engine can identify the document that is represented by the search results. In another example, the search engine can identify each document represented by a search result in the top M search results. The search engine can then retrieve the document and perform a “deep dive” through the document to identify one or more snippets that include information requested by the user by way of the query (e.g., the one or more snippets include an answer to the question included in the query). In further examples, the search engine can return a direct answer extracted from one or more snippets, or may return an answer that is aggregated from document content. With respect to retrieving the document, the search engine can retrieve the document from a search engine cache. In another example, the search engine can retrieve the document from a web server that retains the document (e.g., when the document is not cached in the search engine cache or when the cached document is not recent). The text of the document is parsed to identify snippets therein, and these snippets are ranked. At least the most highly ranked snippet is returned to the client computing device, such that the user is provided with information requested in the query (and the user is not forced to navigate through several web pages to obtain the information).

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary system that facilitates identifying a snippet that addresses an informational need of a search engine user.

FIG. 2 is a functional block diagram of an exemplary system that facilitates ensuring that a snippet is extracted from an up-to-date document.

FIG. 3 is a functional block diagram of an exemplary analysis module.

FIG. 4 is a flow diagram illustrating an exemplary methodology for returning an answer to a query.

FIGS. 5-7 depict exemplary graphical user interfaces.

FIG. 8 is a functional block diagram of an exemplary system that facilitates returning an answer to a query in audio form.

FIG. 9 is an exemplary computing system.

### DETAILED DESCRIPTION

Various technologies pertaining to returning a snippet of a document (e.g., webpage) in response to receipt of a query are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “system”, and “module” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

Generally, described herein are technologies relating to identifying snippets in documents in response to receipt of a query from a client computing device, wherein the documents are parsed to identify the snippets such that an informational need of an issuer of the query is addressed. In more detail, a user sets forth a query to a search engine, wherein the query can be classified as informational in nature. For instance, the query can include a question. The search engine performs a search over a search engine index to generate search results based on the query, and the search engine ranks the search results to construct a ranked list of search results. Further, responsive to ascertaining that the query is informational in nature, the search engine can identify at least one document referenced by a search result in the search results, wherein the at least one document is likely to include information requested by the user via the query. For example, the search engine can maintain a list of domains that often include answers to questions set forth to the search engine by users of the search engine.

When a search result is in the top M search results, and a domain in the search result is equivalent to a domain in the list of domains, the search engine can identify the document that is represented by the search results. In another example, the search engine can identify each document represented by a search result in the top M search results. The search engine can then retrieve the document and perform a “deep dive” through the document to identify a snippet that includes information requested by the user by way of the query (e.g., the snippet includes an answer to the question included in the query). With more specificity, the search engine can retrieve the document from a search engine cache. In another example, the search engine can retrieve the document from a web server that retains the document (e.g., when the document is not cached in the search engine cache or when the cached document is not recent). In yet another example, the client computing device can download the document, and processing described hereafter may be performed on the client computing device. Alternatively, the client computing device can transmit the document to search engine, where the document can be processed and/or maintained in a cache. The text of the document is parsed to identify snippets therein, and these snippets are ranked. At least the most highly ranked snippet is returned to the client computing device, such that the user is provided with information requested in the query (and the user is not forced to navigate through several web pages to obtain the information).

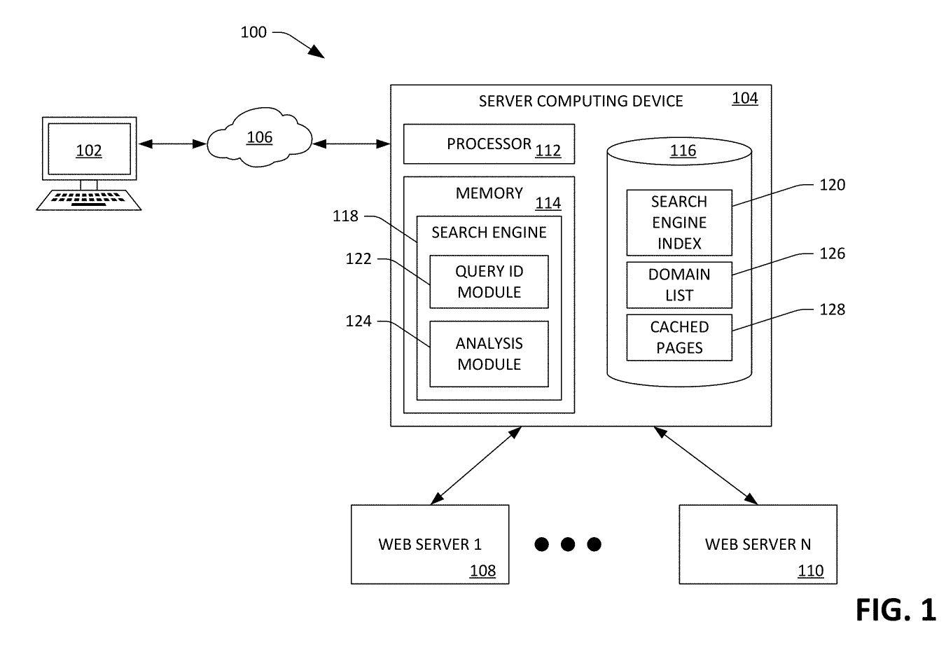

With reference now to FIG. 1, an exemplary system 100 that facilitates presenting a snippet to a user in response to receipt of a query from the user is illustrated, wherein the snipped is identified as including information that satisfies an informational need of the query. The system 100 includes a client computing device 102 and a server computing device 104, wherein the client computing device 102 is in communication with the server computing device 104 by way of a network 106 (e.g., the Internet, an intranet, etc.). The client computing device 102 is operated by a user (not shown). By way of example, and not limitation, the client computing device 102 may be any suitable computing device, including but not limited to a desktop computing device, a laptop computing device, a tablet computing device, a wearable computing device (e.g., a watch or headwear), a smart speaker, a television, a video game console, a portable media player, etc. The system 100 additionally comprises a plurality of web servers 108-110, wherein the web servers 108-110 are in communication with the computing device 104 by way of a network (e.g., the network 106). The web servers 108-110 can host documents (e.g., websites, webpages, etc.) that can be downloaded to the client computing device 102 and retrieved by the server computing device 104.

The server computing device 104 includes a processor 112 and memory 114 that is operably coupled to the processor 112. The memory 114 stores instructions that, when executed by the processor 112, cause the processor 112 to perform acts that will be described in greater detail below. The server computing device also comprises a data store 116 that is operably coupled to the processor 112 and/or the memory 114.

As depicted in FIG. 1, the memory 114 includes a search engine 118, wherein the search engine 118 is configured to generate search results responsive to receipt of a query. With more specificity, the data store 116 includes a search engine index 120, and the search engine 118 searches the search engine index 120 and generates search results. The search engine index 120 may be an inverted index or any other suitable index that can be employed in connection with generating search results. The search engine 118 can additionally rank the search results based upon a variety of ranking criteria, thereby generating a ranked list of S search results, with S being a positive integer.

The search engine 118 includes a query identifier module 122 that is configured to identify informational queries when such queries are received from client computing devices (as opposed to navigational or transactional queries). For example, the query identifier module 122 can label queries that include questions as being navigational queries. In another example, the query identifier module 122 can utilize natural language processing (NLP) technologies to identify informational queries. In still yet another example, the query identifier module 122 can identify informational queries based upon content of search logs, wherein user behavior with respect to search results in the search logs can be indicative of a type of query.

The search engine 118 further includes an analysis module 124 that is in communication with the query identifier module 122. The analysis module 124 is configured to retrieve a document represented by (pointed to by) at least one search result in the ranked list of search results and parse text in the document when the query identifier module 122 ascertains that a received query is informational.

The analysis module 124 can utilize several techniques when determining which document(s) to retrieve. In a first example, the analysis module 124 can receive the ranked list of search results, and can retrieve M documents represented by the top M search results in the ranked list of search results, where M is a positive integer. In another example, the data store 116 may include a domain list 126, which includes a list of web domains whose pages often include answers to informational queries. An exemplary web domain may be a Wiki. The analysis module 124 can compare domains of uniform resource locators (URLs) in the top P search results in the ranked list of search results with domains in the domain list 126, and when a URL belongs to a domain in the domain list 126, the analysis module 124 can retrieve a document represented by the search result.

The analysis module 124 can retrieve documents from a plurality of different sources. For example, the data store 116 can include cached pages 128, wherein the cached pages 128 include documents cached by the search engine 118 when crawling the World Wide Web. When the analysis module 124 retrieves a document, the analysis module 124 can initially access the cached pages 128 to determine whether the document has been cached in the cached pages 128. When the analysis module 124 ascertains that the document has been cached in the cached pages 128, the analysis module 124 can review a timestamp assigned to the cached document to determine how recently the cached document was cached in the cached pages 128. With more specificity, the analysis module 124 can compute a difference between a current time and the time specified in the timestamp, and can retrieve the cached document from the cached pages 128 if the difference is beneath a threshold (e.g., 24 hours). When the timestamp is greater than the threshold, or when the document has not been cached, the analysis module 124 can retrieve the document from one of the web servers 108-110 that houses the document.

Responsive to retrieving a document from the cached pages 128 or from one of the web servers 108-110, the analysis module 124 parses text of the document to identify candidate snippets in the document. For instance, the analysis module 124 can utilized NLP techniques to identify phrases and sentences in the document, and the analysis module 124 can label these phrases and sentences as being candidate snippets. The analysis module 124 then ranks the snippets using any suitable ranking technique, wherein the analysis module 124 identifies the most highly ranked snippet as being most likely to answer the informational need of the user who issued the query. For instance, the analysis module 124 can perform entity linking in the query to identify one or more named entities referenced in the query, can perform syntactic parsing on the query, can perform entity linking on the snippets from the document, can perform syntactic parsing on the snippets from the document, and so forth to acquire an understanding of the informational intent of the user and content of candidate snippets. Hence, it can be ascertained that the analysis module 124 generates a ranked list of snippets. For instance, in connection with ranking the snippets, the analysis module 124 can assign a score to each snippet. The analysis module 124 can cause at least a highest ranking snippet in the ranked list of snippets to be returned to a client computing device from which the query was received. In another example, the analysis module 124 can cause all snippets with a score above a threshold to be returned to the client computing device. Further, as will be described below, there are numerous manners in which the snippet can be presented on a client computing device.

The analysis module 124 can perform several other operations based upon the parsing of the text of the document. In an example, the analysis module 124 can update the search engine index 120 based upon parsing text of the document, such that the search engine index 120 is current with respect to content of the document. In another example, an “instant answer” index (not shown) may be updated with content from the snippet. In still yet another example, the search engine 118 can re-rank the search results based upon snippets extracted from documents. For instance, the analysis module 124 can determine that a snippet from a document that is represented by a fourth most highly ranked search result is highly relevant to the query, and the search engine 118 can re-rank the search results such that a search result that represents the document is the most highly ranked search result. Moreover, in addition to the snippet being returned to the client computing device, the search engine 118 can return the (possibly re-ranked) ranked list of search results to the client computing device.

Exemplary operation of the system 100 is now set forth for purposes of explanation. A user of the client computing device 102 may set forth the query “how many grains of sand are in the Sahara Desert?” to the client computing device 102, and the client computing device 102 can transmit the query to the server computing device 104 over the network 106. The server computing device 104, responsive to receiving such query, directs the query to the search engine 118 being executed by the processor 112.

The search engine 118 generates search results for the query by searching over the search engine index 120 based upon the query. The search engine 118 additionally employs a suitable ranking algorithm to rank the search results based upon features of documents (web pages) represented in the search engine index and features of the query. Therefore, the search engine 118 generates a ranked list of search results for the query, wherein the ranked list of search results includes URLs to documents represented by the search results.

The query identifier module 122 receives the query and ascertains that the query includes a question. Responsive to ascertaining that the query includes the question, the query identifier module 122 invokes the analysis module 124. The analysis module 124 receives the ranked list of search results and retrieves at least one document from the cached pages 128 and/or the web servers 108-110. For example, the analysis module 124 can identify domains in the URLs of the search results, and can search the domain list 126 for such domains. When a domain in a URL of the top M search results is included in a domain in the domain list 126, the analysis module 124 retrieves the document pointed to by the URL from the cached pages 128 or one of the web servers 108-110. For example, a second most highly ranked search result may be a Wiki page, wherein the domain list includes a domain for the Wiki page. The analysis module 124 can retrieve such page from the cached pages 128 (if available). When the cached page is unavailable or not recent, the analysis module 124 retrieves the Wiki page from one of the web servers 108-110 that hosts the Wiki page. Alternatively, the analysis module 124 can go directly to the web server (e.g., to ensure that the page in its current form is retrieved). This process can be repeated for several documents represented in the ranked list of search results.

The analysis module 124 then parses text in the retrieved document to identify candidate snippets, where a snippet can be a sentence, a phrase, a table, or the like. The analysis module 124 subsequently ranks the snippets through utilization of NLP techniques, including entity linking, syntactic parsing, and so forth, wherein such processing is performed on both the query and candidate snippets. Continuing with this example, the Wiki page may include an entry that states “There is over 8.0*10̂27 grains of sand in the Sahara Desert.” This snippet answers the question posed in the query. Further, this process is especially well-suited for questions where there may be some variability in the answers or where a fact may change over time. For instance, two different pages may have different estimates for the number of grains of sand in the Sahara Desert—accordingly, such query is not well-suited to be answered by way of an instant answer. The search engine 118 returns at least the snippet to the client computing device 102. In addition, the search engine 118 can return the ranked list of search results to the client computing device 102.

The approach described herein offers various advantages over conventional approaches. As indicated previously, as the analysis module 124 extracts snippets from documents that are retrieved from the cached pages 128 or from the web servers 108-110, the snippets include recent information (e.g., the information extracted from the documents is not out of date). Additionally, as the analysis module 124 considers semantics of documents when extracting and ranking snippets, the system 100 offers advantages over conventional keyword-matching approaches, which are limited to searching for keywords in the document that match keywords in the query.

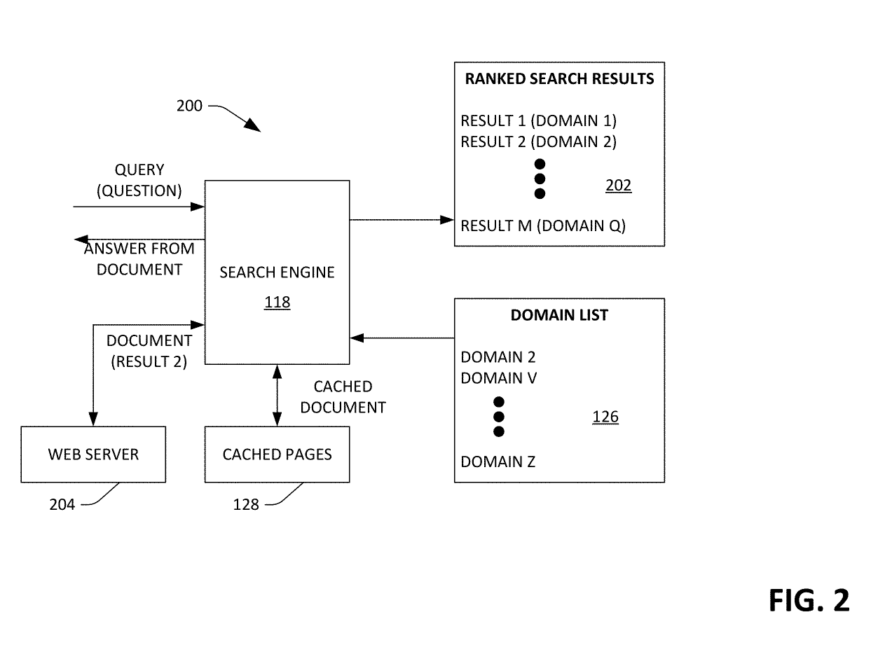

With reference now to FIG. 2, another exemplary functional block diagram of an exemplary system 200 that facilitates returning a snippet extracted from a document to an issuer of a query is illustrated. The system 200 includes the search engine 118, which receives a query (e.g., from the client computing device 102), wherein the query includes a question. The search engine 118, responsive to receiving the query, executes a search over the search engine index 120 to generate search results, and subsequently ranks the search results to generate a ranked list of search results 202. As can be ascertained from FIG. 2, the ranked list of search results includes a first search result, which includes a URL of a first domain, a second search results, which includes a URL of a second domain, through an Mth search result, which includes a URL of a Qth domain. In this example, there may be more search results; however, the ranked list of search results 202 depicts the top M search results.

In the example depicted in FIG. 2, the analysis module 124 (not shown) compares domains of the URLs in the ranked list of search results 202 with domains in the domain list 126, and determines that the second search result in the ranked search results 202 is a URL of a domain that is in the domain list 126 (domain 2). Responsive to determining that the URL of the second search result has a domain in the domain list 126, the analysis module 124 retrieves a cached version of the document represented by the URL from the cached pages 128. The analysis module 124 compares a timestamp assigned to the cached document with a current time, wherein the timestamp indicates when the cached document was placed in the cached pages 128. When a difference between a time in the timestamp and a current time is greater than a predefined threshold (e.g., when the cached document is not a recent version of the document), the analysis module 124 can retrieve the document from a web server 204 that houses the document. This ensures that the analysis module 124 acquires the most recent version of the document. The analysis module 124 thereafter identifies candidate snippets in the document, ranks the snippets, and causes the search engine 118 to return at least the most highly ranked snippet to the client computing device that issues the query, thereby providing a user of the client computing device with an answer to the question included in the query.

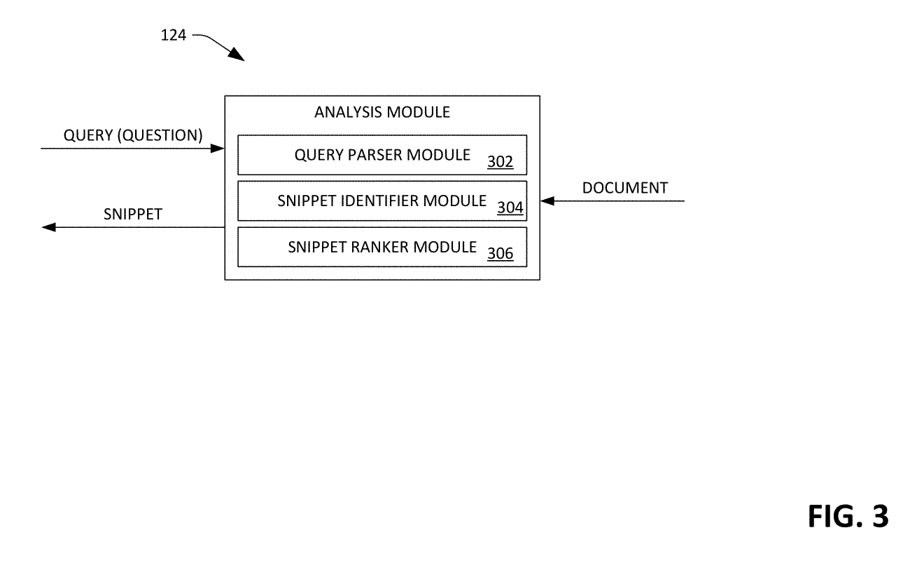

Referring to FIG. 3, a functional block diagram of the analysis module 124 is illustrated. The analysis module 124 includes a query parser module 302, a snippet identifier module 304, and a snippet ranker module 306. The analysis module 124 receives a query that includes a question. The query parser module 302 parses the query to ascertain semantics of the query. For instance, the query parser module 302 can perform entity linking, syntactic parsing, and the like in connection with ascertaining semantics of the query. The snippet identifier module 304 identifies candidate snippets in a document—for example, the snippet identifier module 304 can search for punctuation in the document, white space in the document, etc. In another example, the snippet identifier module 304 can perform semantic processing to identify candidate snippets. The snippet ranker module 306 ranks the candidate snippets. For example, the snippet ranker module 306 can assign a score to each snippet, wherein the score is indicative of a confidence level that a snippet includes an answer to the question included in the query. The analysis module 124 can return each snippet with a score above a predefined threshold to the computing device that issued the query. In another example, the analysis module 124 may return only the most highly ranked snippet.

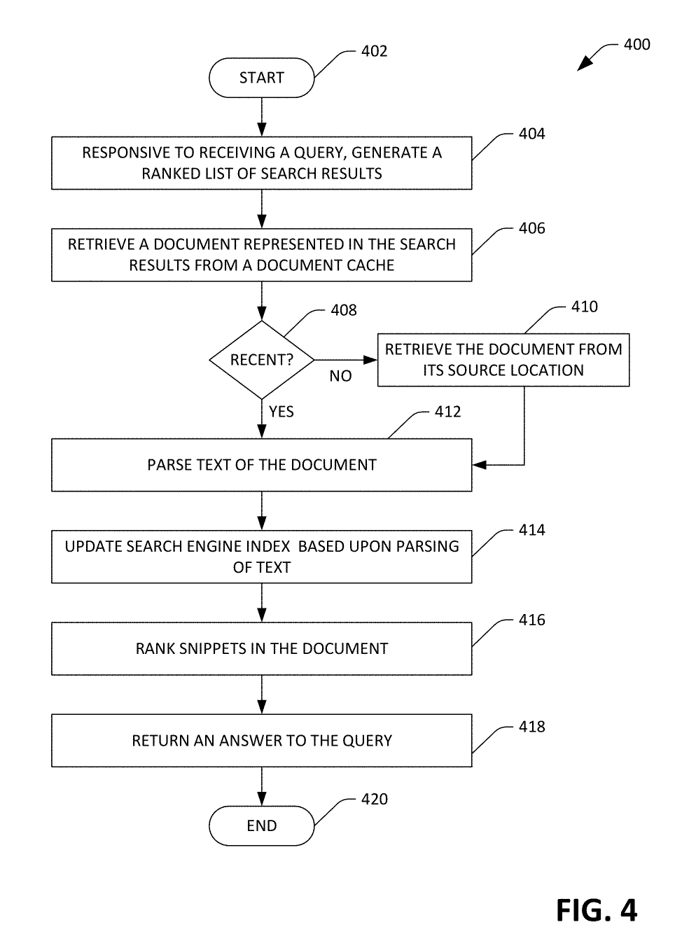

FIG. 4 illustrates an exemplary methodology relating to identifying a snippet from a document that answers a question included in a user query and returning the snippet to a client computing device. While the methodology is shown and described as being a series of acts that are performed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 4 depicts an exemplary methodology 400 for returning an answer to a question set forth in a query received from a client computing device. The methodology 400 starts at 402, and at 404 a ranked list of search results is generated in response to receipt of a query (where the query includes a question). At 406, a document that is represented in the search results is retrieved from a document cache (e.g., documents cached by a search engine).

At 408, a determination is made regarding whether the document retrieved from the document cache was recently cached. In other words, a determination is made regarding whether a time since the document was included in the document cache is greater than a predefined threshold. If it is determined at 408 that the document in the document cache is stale, then at 410 the document is retrieved from its source network location (e.g., a web server that houses the document), and the methodology 400 proceeds to 412. Alternatively, if it is determined at 408 that the document was recently cached in the document cache, the methodology 400 proceeds directly to 412.

At 412, text of the document is parsed, wherein parsing the text may include performing entity linking with respect to the text of the document, performing syntactic parsing, etc. While not shown, the query may also be parsed. At 414, a search engine index is updated based upon the parsing of the text. At 416, snippets of the document are ranked based upon the likelihood that the snippets answer the question set forth in the query. At 418, an answer to the query is returned to a client computing device, wherein the answer is included in at least one snippet returned to the client computing device. The methodology 400 completes at 420.

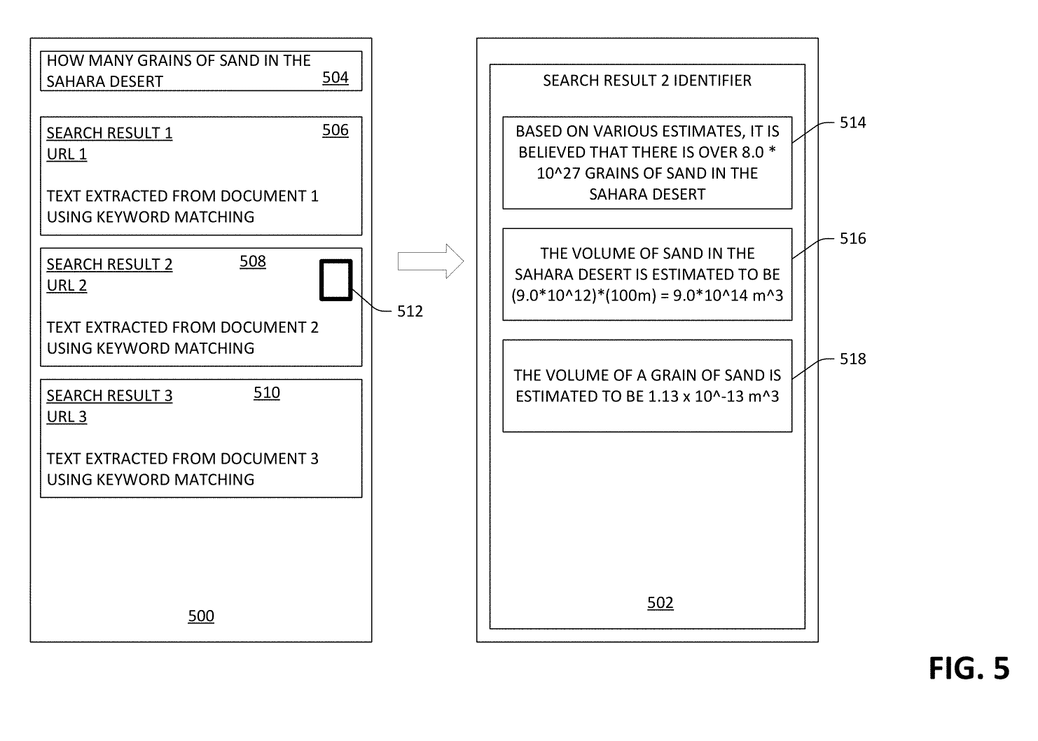

With reference now to FIG. 5, exemplary graphical user interfaces (GUIs) 500 and 502 are illustrated. The GUI 500 includes a query field 504, wherein the query “how many grains of sand in the Sahara Desert?” has been set forth in the query field 504. The GUI 500 further includes several search results 506, 508, and 510 returned by a search engine (e.g., the search engine 118) responsive to receipt of the query. Each of the search results 506-510 includes a link to a page represented by the search result, a URL for the page, and (optionally) text extracted from the page using keyword matching. Additionally, the second search result 508 includes a selectable graphic 512, which can indicate to an end user that the document represented by the second search result can be parsed by the analysis module 124, such that at least one snippet extracted from the document can be returned. The GUI 502 is presented on a display after the selectable graphic 512 has been selected (e.g., clicked using a mouse pointer, selected with a finger or stylus, selected via voice commands, etc.). The GUI 502 includes an identifier for the document represented by the second search result, and also includes a plurality of snippets 514-518 extracted from the document, where at least one of the snippets includes an answer to the question included in the query. An advantage to presenting the snippets in the manner shown in FIG. 5 is that the document need not be retrieved and the snippets need not be extracted from the document and ranked until after the user has selected the selectable graphic 512, this can mitigate latency issues that may arise if search engine 118 attempts to immediately return search results, retrieve one or more documents from their source locations, rank snippets in such documents, etc.

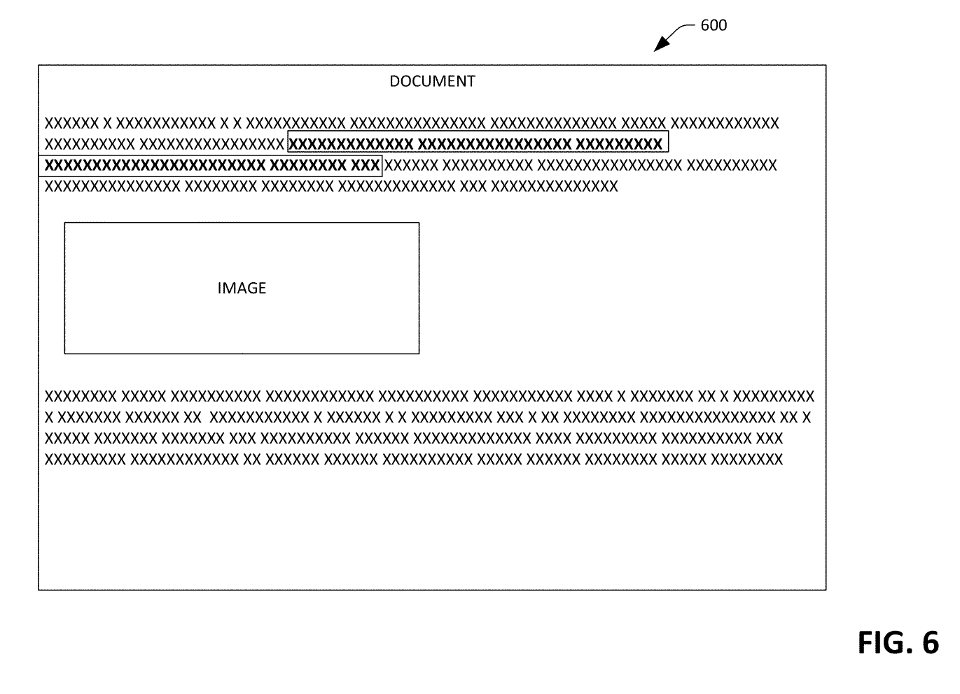

Referring now to FIG. 6, another exemplary GUI 600 is presented. The GUI 500 is of a document that is presented on a display of a client computing device after an end user has selected a search result corresponding to the document. With more specificity, the document is identified by the search engine 118 as being relevant to a query submitted to the search engine by the end user. When the search result is selected, the search engine 118 highlights at least one snippet in the document that has been identified by the analysis module 124 as potentially answering a question set forth in the query. Thus, the end user can be immediately directed to the answer. Further, the search engine 118 can cause the document to be presented such that the snippet is immediately visible to the end user. In an example, when the snippet is at the bottom of a long document, the search engine 118 can cause the bottom of the document (which includes the snippet) to be immediately presented to the end user.

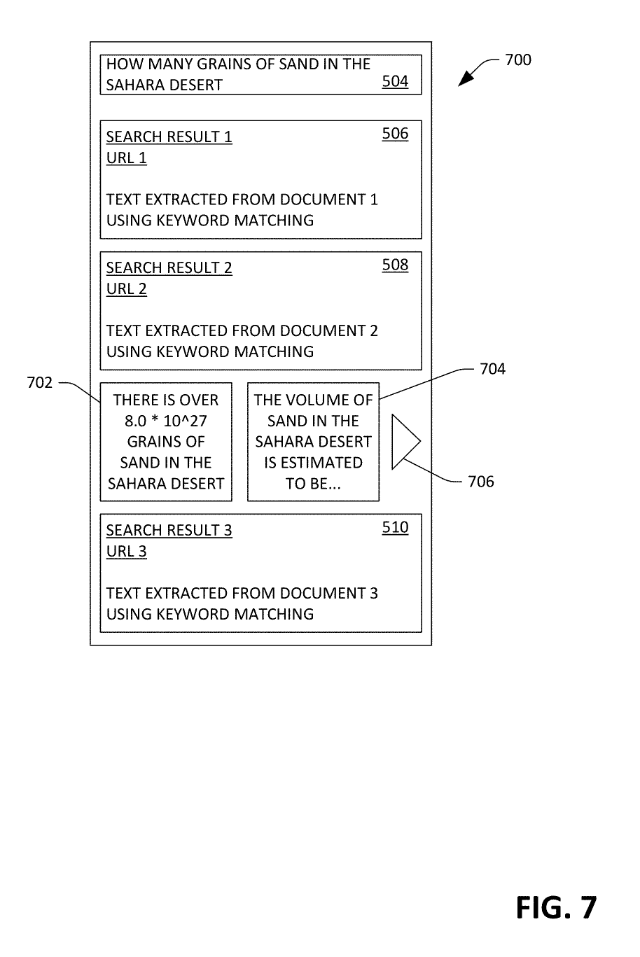

Turning now to FIG. 7, another exemplary GUI 700 is illustrated, wherein snippets extracted from a document by the analysis module 124 are presented in-line with a search result that represents the document (e.g., in carousel form). The GUI 700 includes the query field 504 and the search results 506-510. The GUI 700 also includes snippets extracted from document 2 (the document pointed to by the second search result 508). The GUI 700 also includes snippets 702 and 704, which have been identified by the analysis module 124 as potentially including an answer to the query. An arrow 706 indicates that there are additional snippets that have been extracted from document 2.

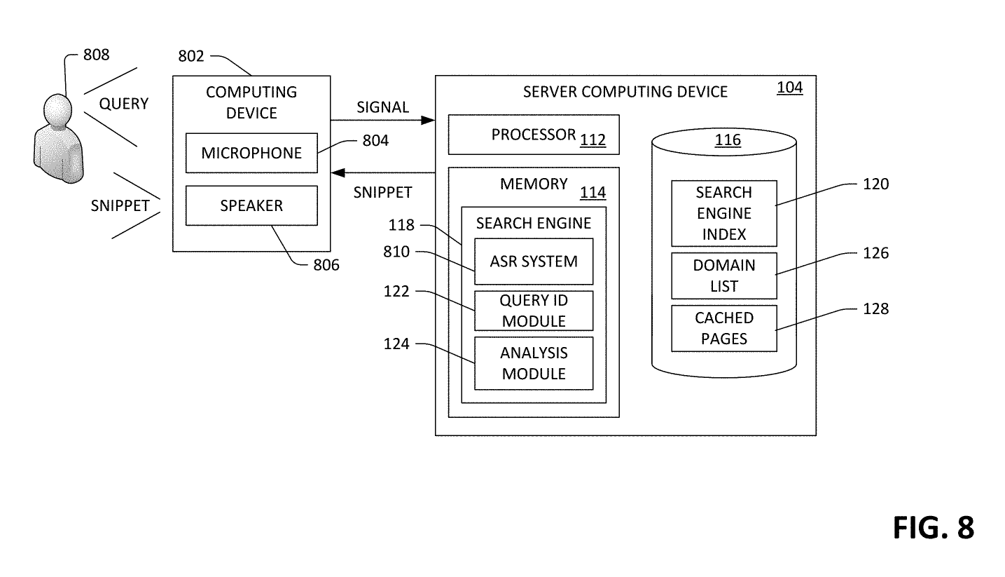

With reference to FIG. 8, an exemplary system 800 that facilitates returning an answer to a query set forth by a user is illustrated. The system 800 includes a client computing device 802, wherein the client computing device 802 includes a microphone 804 and a speaker 806. The system 800 further includes the server computing device 104, which is in network communication with the client computing device 802. In an example, the client computing device 802 may be a “smart speaker”. In operation, a user 808 of the client computing device 802 sets forth a query by way of voice, wherein the query includes a question. The microphone 804 generates a voice signal based upon the spoken query, and transmits a signal to the server computing device 104 that is based upon the voice signal. For instance, the signal may be the voice signal, or may be features extracted from the voice signal.

In the exemplary system 800, the search engine 118 includes or is in communication with an automatic speech recognition (ASR) system 810. The ASR system 819 translates the signal into text, such that the search engine 118 receives the query in a form such that the search engine 118 can process the query. Once the query is translated into text, the search engine 118 operates as described above, wherein the search engine 118 generates a ranked list of search results based upon the query, at least one document represented in the search results is retrieved, and at least one snippet is identified in the at least one document as including an answer to the query. Responsive to the search engine 118 identifying the snippet, the search engine 118 can transmit the snippet to the client computing device 802, which can include a text to speech system (not shown). Accordingly, the speaker 806 outputs the snippet. The speaker 806 may additionally output an identifier for the source of the snippet. In an alternative embodiment, the search engine 118 can include the text to speech system, and can transmit audio to the client computing device 802, whereupon it can be output by the speaker 806.

While the technologies described herein have related to parsing documents that are in search results, it is to be understood that such technologies may be applicable to parse a document or documents identified by an end user. For instance, the end user may identify a document that the end user believes includes an answer to a question, however, the document may be lengthy. The end user can set forth the query, identify the document, and the analysis module 124 can parse such document (as described above). The analysis module may then output at least one snippet from the document that is believed to answer the question set forth by the end user.

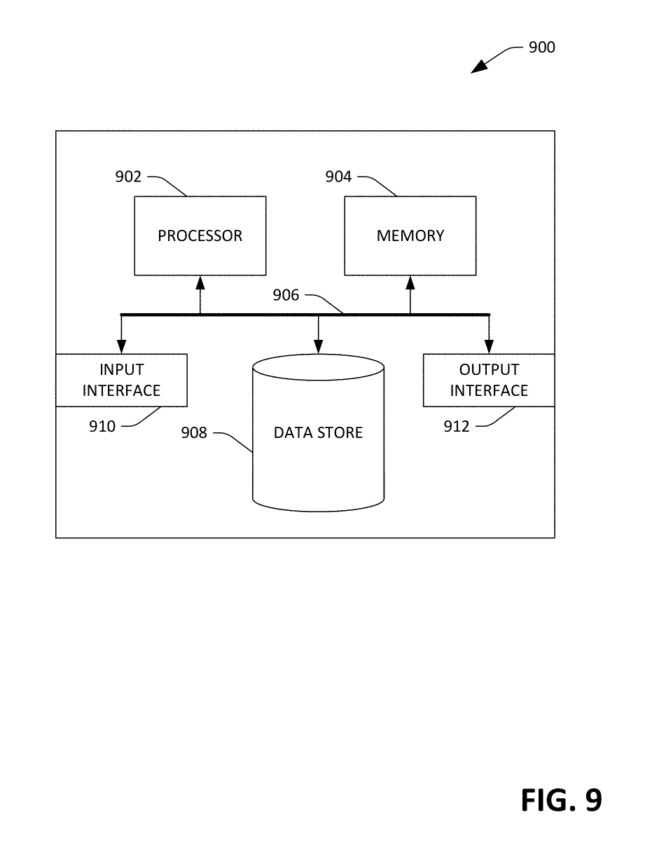

Referring now to FIG. 9, a high-level illustration of an exemplary computing device 900 that can be used in accordance with the systems and methodologies disclosed herein is illustrated. For instance, the computing device 900 may be used in a system that identifies snippets. By way of another example, the computing device 900 can be used in a system that generates ranked lists of search results. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store cached documents, a domain list, a search engine index, etc.

The computing device 900 additionally includes a data store 908 that is accessible by the processor 902 by way of the system bus 906. The data store 908 may include executable instructions, a domain list, a search engine index, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 900 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for instance, several devices may be in communication by way of a network connection and may collectively perform tasks described as being performed by the computing device 900.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor, and
memory storing instructions that, when executed by the processor, cause the processor to perform acts comprising:
receiving a query from a client computing device that is in network communication with the computing system, wherein the query includes a question;
generating a ranked list of search results based upon the query;
responsive to the ranked list of search results being generated based upon the query, identifying a document represented by a search result in the search results;
responsive to identifying the document, retrieving the document from computer-readable storage;
parsing text of the document retrieved from the computer-readable storage;
responsive to parsing the text of the document and based upon the parsing of the text of the document, identifying a snippet from the document that includes an answer to the question in the query; and
transmitting, to the client computing device, the snippet that has been identified as including the answer to the question in the query.

2. The computing system of claim 1, wherein retrieving the document from computer-readable storage comprises retrieving a cached version of the document from a search engine cache.

3. The computing system of claim 1, wherein retrieving the document from computer-readable storage comprises retrieving the document from a web server that retains the document.

4. The computing system of claim 1, wherein retrieving the document from computer-readable storage comprises:
retrieving a cached version of the document from a search engine cache;
based upon a timestamp assigned to the cached version of the document, determining that a threshold amount of time has passed since the cached version of the document was created; and
responsive to determining that the threshold amount of time has passed since the cached version of the document was created, retrieving the document from a web server that retains the document.

5. The computing system of claim 1, wherein identifying the document represented in the search results comprises:
identifying a domain in a uniform resource locator (URL) for the document;
determining that the domain is included in a predefined list of domains; and
identifying the document based upon the domain in the URL for the document being included in the predefined list of domains.

6. The computing system of claim 1, wherein identifying the document represented in the search results comprises determining that the search results is one of N most highly ranked search results in the ranked list of search results, where N is a positive integer.

7. The computing system of claim 1, wherein generating the ranked list of search results comprises searching over a search engine index based upon the query, the acts further comprising:
updating the search engine index based upon the parsing of the text of the document.

8. The computing system of claim 1, wherein identifying the snippet from the document comprises:
extracting multiple snippets from the document, each snippet includes at least one sentence; and
ranking the multiple snippets, wherein the snippet is a most highly ranked snippet in the multiple snippets extracted from the document.

9. The computing system of claim 1, the acts further comprising:
responsive to generating the ranked list of search results based upon the query, transmitting the ranked list of search results to the client computing device, wherein the search result is highlighted to indicate that the snippet is available;
receiving, from the client computing device, a request for the snippet; and
performing the acts of retrieving, parsing, identifying, and transmitting only after receiving the request for the snipped from the client computing device.

10. The computing system of claim 1, wherein the query is a voice query, and further wherein the snippet is transmitted as audio to the client computing device for output by a speaker of the client computing device.

11. A method executed by a server computing device, the method comprising:
receiving a query from a client computing device that is in network communication with the server computing device, wherein the query includes a question;
generating a ranked list of search results based upon the query;
responsive to the ranked list of search results being generated based upon the query, identifying a document represented by a search result in the search results;
responsive to identifying the document, retrieving the document from computer-readable storage;
parsing text of the document retrieved from the computer-readable storage;
responsive to parsing the text of the document and based upon the parsing of the text of the document, identifying a snippet from the document that includes an answer to the question in the query; and
transmitting, to the client computing device, the snippet that has been identified as including the answer to the question in the query.

12. The method of claim 11, wherein retrieving the document from computer-readable storage comprises retrieving a cached version of the document from a search engine cache.

13. The method of claim 11, wherein retrieving the document from computer-readable storage comprises retrieving the document from a web server that retains the document.

14. The method of claim 11, wherein retrieving the document from computer-readable storage comprises:
retrieving a cached version of the document from a search engine cache;
based upon a timestamp assigned to the cached version of the document, determining that a threshold amount of time has passed since the cached version of the document was created; and
responsive to determining that the threshold amount of time has passed since the cached version of the document was created, retrieving the document from a web server that retains the document.

15. The method of claim 11, wherein identifying the document represented in the search results comprises:
identifying a domain in a uniform resource locator (URL) for the document;
determining that the domain is included in a predefined list of domains; and
identifying the document based upon the domain in the URL for the document being included in the predefined list of domains.

16. The method of claim 11, wherein identifying the document represented in the search results comprises determining that the search results is one of M most highly ranked search results in the ranked list of search results, where M is a positive integer.

17. The method of claim 11, wherein generating the ranked list of search results comprises searching over a search engine index based upon the query, the acts further comprising:
updating the search engine index based upon the parsing of the text of the document.

18. The method of claim 17, wherein identifying the snippet from the document comprises:
extracting multiple snippets from the document, each snippet includes at least one sentence; and
ranking the multiple snippets, wherein the snippet is a most highly ranked snippet in the multiple snippets extracted from the document.

19. The method of claim 11, the acts further comprising:
responsive to generating the ranked list of search results based upon the query, transmitting the ranked list of search results to the client computing device, wherein the search result is highlighted to indicate that the snippet is available;
receiving, from the client computing device, a request for the snippet; and
performing the acts of retrieving, parsing, identifying, and transmitting only after receiving the request for the snipped from the client computing device.

20. A computer-readable storage medium comprising instructions that, when executed by a processor, cause the processor to perform acts comprising:
receiving a query from a client computing device, wherein the query includes a question;
responsive to receiving the query, generating a ranked list of search results based upon the query, wherein search results in the ranked list of search results represent documents;
responsive to generating the ranked list of search results, retrieving a document in the documents from a web server that hosts the document;
parsing the document retrieved from the web server to identify candidate snippets therein;
ranking the candidate snippets responsive to parsing the document, wherein the snippets are ranked based upon a confidence that the snippets include an answer to the question in the query; and
returning the ranked list of search results and a most highly ranked snippet to the client computing device for presentment on a display of the client computing device.
